(19) United States
(12) Patent Application Publication
(10) Pub. No.: US 2024/0219613 A1
(43) Pub. Date: Jul. 4, 2024

(54) REFLECTIVE WIRE WITH LONG-ACTING RETROREFLECTION MECHANISM AND METHOD FOR MAKING THE SAME

(71) Applicant: Cheng-Lang TSAI, New Taipei City (TW)

(72) Inventor: Cheng-Lang TSAI, New Taipei City (TW)

(21) Appl. No.: 18/386,255

(22) Filed: Nov. 2, 2023

(30) Foreign Application Priority Data
Jan. 3, 2023 (TW) 112100132

(51) Int. Cl. G02B 5/136

(52) U.S. Cl. CPC G02B 5/136

(57) ABSTRACT

A reflective wire with a long-acting retroreflection mechanism and the method for making it include fixedly coating reflective balls to a side of a film layer to form at least one reflective strip, and providing a transparent protective film on the reflective strip to form the reflective wire. The reflective balls are disposed between the transparent protective film and the film layer, and gaps allowing passage of air are formed between the reflective balls. In this way, the reflective balls are kept from being worn away by an external object during subsequent processing or use, and therefore stay highly reflective, and foreign matter cannot build up in the gaps between the reflective balls. Accordingly, the reflective wire remains reflective as intended after longtime use.

### CROSS-REFERENCE TO RELATED PATENT APPLICATION

This non-provisional application claims priority to and the benefit of, under 35 U.S.C. § 119(a), Taiwan Patent Application No. 112100132, filed Jan. 3, 2023 in Taiwan. The entire content of the above identified application is incorporated herein by reference.

### FIELD

The present disclosure relates to a reflective wire, and more particularly to a reflective wire where a plurality of reflective balls are disposed between a transparent protective film and a film layer without exposure to the outside.

### BACKGROUND

Products that are commonly described on the market as made of “reflective materials” can be those made through a special production technique developed by 3M Company. Referring to FIG. 1, such a reflective material R works mainly on the principle of retroreflection: an incident ray of light P striking the reflective material R results in a ray of reflected light Q that propagates back to the light source S, or to a position adjacent thereto, along the path of the incident ray of light P, making the reflective material R highly noticeable to an observer near the light source S and hence readily visible in a poorly illuminated environment. The reflective material R has been applied to clothes and articles of use in many different fields (e.g., clothes and articles for household, leisure, sports, or military use) and can be made into various customized reflective products according users' functional requirements.

The structure and manufacturing process of the aforesaid reflective material are briefly described below with reference to FIG. 1 and FIG. 2. First, light-permeable glass beads 10 with high clarity, a uniform small diameter, and a smooth surface are made by grinding with a particular grinding machine. Thereafter, the light-permeable glass beads 10 are coated with an aluminum material. More specifically, half of the spherical surface of each light-permeable glass bead 10 is coated with a mirror coating layer 11 that functions as a reflective layer for retroreflection and thereby renders the light-permeable glass bead 10 into a reflective ball 1. The desired reflective material R can then be made by distributing a plurality of reflective balls 1 on an object. In terms of use, however, the conventional reflective material R has the following issues. Referring to FIG. 3, a manufacturer intending to enhance retroreflection may distribute the reflective balls 1 directly on the surface of an object 2 (e.g., a piece of clothes or a woven ribbon/strip) in such a way that the reflective balls 1 are exposed, so that the incident ray of light P entering each light-permeable glass bead 10 will be reflected by the corresponding mirror coating layer 11 to form the ray of reflected light Q, which exits the light-permeable glass bead 10. As the incident and reflected light propagates through only two media (i.e., the light-permeable glass bead 10 and the air surrounding it), a better reflecting effect can be achieved.

However, after long-term use, some of the reflective balls 1 may have been worn or scratched on the surface, deformed, or even broken by an external force; or some of the reflective balls 1 may have fallen off the surface of the object 2; or foreign matter (e.g., dirt or grease) may have built up between adjacent reflective balls 1. Should any of the aforementioned conditions take place, the retroreflectivity of the reflective material R will be lost or significantly reduced; in other words, the service life of the reflective material R will be shortened to a great extent. Accordingly, one of the issues to be addressed in the present disclosure is to provide an effective solution thereto.

### SUMMARY

Designs and experiments according to the present disclosure include providing additional protective layer on a plurality of reflective balls by coating the surfaces of the reflective balls with glue and then adhering the protective layer to the reflective balls. Nevertheless, the glue may enter the gaps between adjacent reflective balls, causing unnecessary diffuse reflection, thereby greatly compromising the optimal retroreflection that was supposed to happen; in some cases, the diffuse reflection even caused a loss of the intended reflection. Designs and experiments according to the present disclosure also include applying an extrusion molding method to coat the surfaces of the reflective balls with molten transparent plastic. Nevertheless, as in the case with glue, the reflective material does not produce the desired reflection. In light of the above-referenced experiment results according to the present disclosure, based on years of extensive practical experience in professional product design, processing, and manufacture, and the research spirit for excellence, and as a result of longtime labored research and experiment, the present disclosure provides a reflective wire with a long-acting retroreflection mechanism and a method for making the same, so as to provide users with better products and better user experience.

Certain aspects of the present disclosure are directed to a reflective wire with a long-acting retroreflection mechanism. The reflective wire includes at least one reflective strip and a transparent protective film. The at least one reflective strip includes a film layer and a plurality of reflective balls. One side of the film layer is fixedly coated with the reflective balls. The transparent protective film is provided on the at least one reflective strip. Gaps allowing passage of air are formed between the reflective balls. The reflective balls are kept from being worn away by an external object during subsequent processing or use, and therefore stay highly reflective, and foreign matter cannot build up in the gaps between the reflective balls. Accordingly, the reflective wire remains reflective as intended after longtime use.

In certain embodiments, the reflective wire further includes a supporting wire element, the at least one reflective strip is provided on the supporting wire element, and the other side of the film layer abuts the supporting wire element.

In certain embodiments, the reflective wire further includes a transparent plasticized coating layer provided on an outer surface of the transparent protective film.

In certain embodiments, the supporting wire element is made of at least one of a metal material and a plasticized material.

In certain embodiments, each of the reflective balls is a light-permeable bead with high clarity, and half of the spherical surface of the light-permeable bead has a mirror coating layer as a reflective layer for retroreflection.

In certain embodiments, the at least one reflective strip is wrapped around the surface of the supporting wire element by winding or weaving, and the corresponding edges of each two adjacent turns of the at least one reflective strip abut or substantially abut each other.

In certain embodiments, the at least one reflective strip is wrapped around the surface of the supporting wire element by winding or weaving, and the corresponding edges of each two adjacent turns of the at least one reflective strip overlap.

In certain embodiments, the width of the overlapping portion between each two adjacent turns of the at least one reflective strip is 10% to 50% of the width of the film layer.

In certain embodiments, the at least one reflective strip is wrapped around the surface of the supporting wire element by winding or weaving, and the corresponding edges of each two adjacent turns of the at least one reflective strip are spaced apart by a distance.

In certain embodiments, the transparent protective film has a width ranging from 1.0 mm to 4.0 mm and a thickness ranging from 0.01 mm to 0.05 mm.

In certain embodiments, the plasticized coating layer has a thickness ranging from 0.50 mm to 3.00 mm.

Certain aspects of the present disclosure are directed to a method for making a reflective wire with a long-acting retroreflection mechanism. The method includes: fixing a plurality of reflective balls to a side of a film layer to form at least one reflective strip, and providing a transparent protective film on the at least one reflective strip to form the reflective wire. The reflective balls are disposed between the transparent protective film and the film layer, and gaps allowing passage of air are formed between the reflective balls. Accordingly, as the method according to the present disclosure keeps the reflective balls from direct exposure to the outside, and gaps allowing passage of air are kept between the reflective balls, the reflectivity of the reflective balls are not affected.

In certain embodiments, the method further includes, before providing the transparent protective film on the at least one reflective strip, providing the at least one reflective strip on a supporting wire element with the other side of the film layer abutting the supporting wire element.

In certain embodiments, the supporting wire element is a wire made of a malleable material by extrusion molding, and the malleable material is made of at least one of a metal material and a plasticized material that is malleable by an external force.

In certain embodiments, the method further includes coating aluminum on half of the spherical surface of each of light-permeable beads with high clarity that is ground smooth by a grinding machine to form a mirror coating layer on the half of the spherical surface as a reflective layer for retroreflection, and to form the reflective balls capable of retroreflection over a wide angle.

In certain embodiments, the supporting wire element is embedded therein with at least one wire core made of an electrically conductive metal or a fibrous material.

In certain embodiments, the step of forming the at least one reflective strip includes: applying an adhesive to the side of the film layer; attaching the reflective balls to, and positioned the reflective balls on, the side of the film layer via the adhesive; and drying the film layer to cure the adhesive and fix the reflective balls on the side of the film layer.

In certain embodiments, the method includes wrapping the at least one reflective strip around a surface of the supporting wire element by winding or weaving, with the corresponding edges of each two adjacent turns of the at least one reflective strip abutting or substantially abutting each other.

In certain embodiments, the method includes wrapping the at least one reflective strip around a surface of the supporting wire element by winding or weaving, with the corresponding edges of each two adjacent turns of the at least one reflective strip overlapping.

In certain embodiments, the method includes wrapping the at least one reflective strip around a surface of the supporting wire element by winding or weaving, with the corresponding edges of each two adjacent turns of the at least one reflective strip being spaced apart by a distance.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic diagram of the principle of retroreflection.

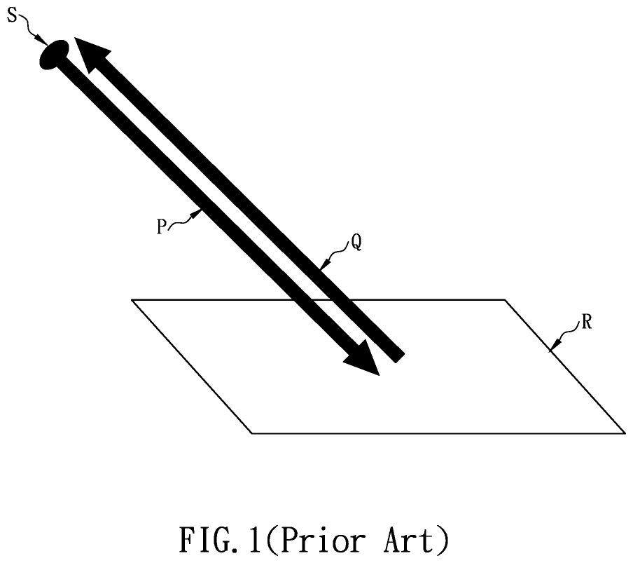

FIG. 2 is a schematic structural diagram of a conventional reflective ball producing retroreflection effects.

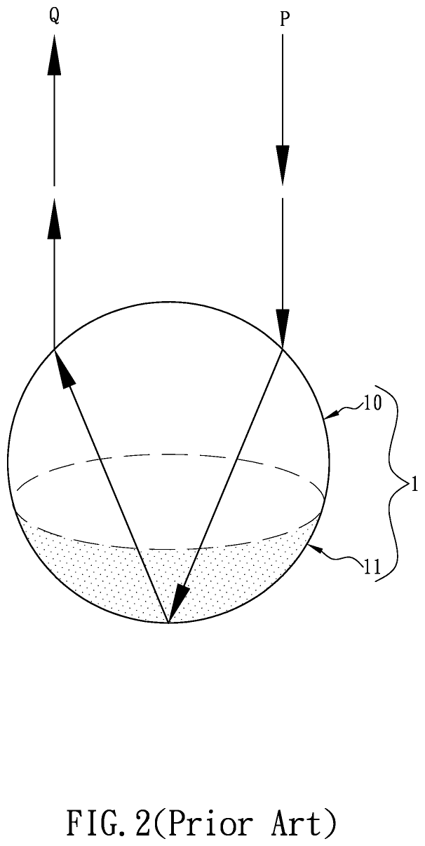

FIG. 3 is a schematic structural diagram of a conventional reflective article producing retroreflection effects.

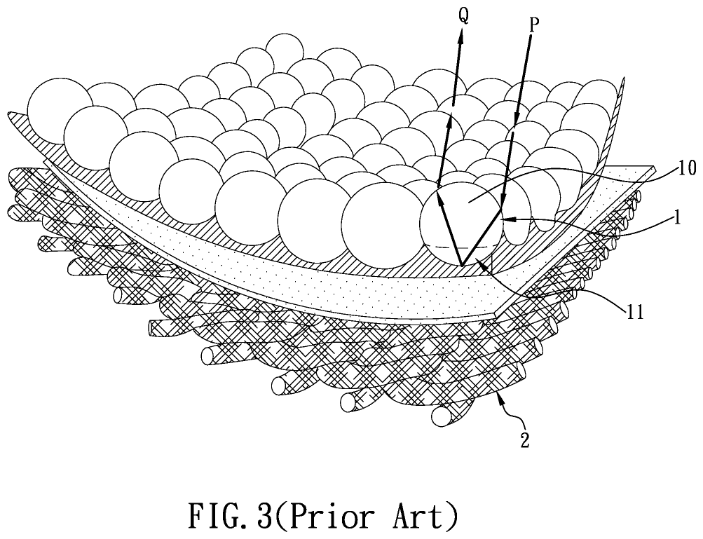

FIG. 4 is a schematic structural diagram of a reflective wire according to certain embodiments of the present disclosure.

FIG. 5 is a schematic diagram showing adjacent turns of at least one reflective strip overlap according to certain embodiments of the present disclosure.

FIG. 6 is a schematic diagram showing adjacent turns of at least one reflective strip are spaced apart from each other by a distance according to certain embodiments of the present disclosure.

FIG. 7 is a flowchart of a method for making at least one reflective strip according to certain embodiments of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The accompanying drawings are schematic and may not have been drawn to scale. The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, materials, objects, or the like, which are for distinguishing one component/material/object from another one only, and are not intended to, nor should be construed to impose any substantive limitations on the components, materials, objects, or the like. Directional terms (e.g., “front”, “rear”, “left”, “right”, “upper/top” and/or “lower/bottom”) are explanatory only and are not intended to be restrictive of the scope of the present disclosure.

As may be used herein, the term “substantially” refers to, for example, a value, or an average of values, in an acceptable deviation range of a particular value recognized or decided by a person of ordinary skill in the art, taking into account any specific quantity of errors related to the measurement of the value that may resulted from limitations of a measurement system or device. For example, “substantially” may indicate that the value is within, for example, ±5%, ±3%, ±1%, ±0.5% or ±0.1%, or one or more standard deviations, of the particular value.

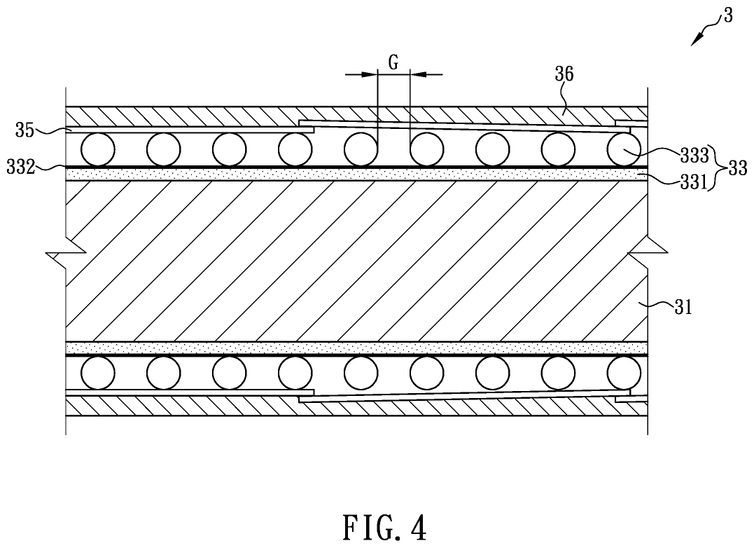

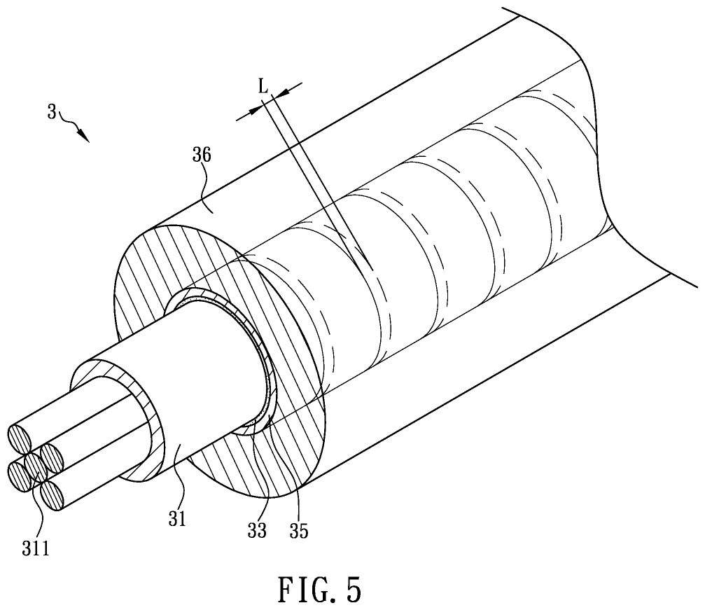

Certain aspects of the present disclosure are directed to a reflective wire having a long-acting retroreflection mechanism and a method for making the same. Referring to FIG. 4 and FIG. 5, in certain embodiments, the reflective wire 3 includes a supporting wire element 31, at least one reflective strip 33, and a transparent protective film 35. The supporting wire element 31 can be made of a malleable material by extrusion molding. However, the present disclosure is note limited thereto. The malleable material can be a metal material (e.g., an iron wire), a plasticized material, a material made of a metal material mixed with a plasticized material, or other materials that can be malleably shaped by an external force. For example, in certain embodiments, the supporting wire element 31 can be a wire element that is made of a plasticized material and is embedded therein with at least one wire core 311 made of an electrically conductive metal or a fibrous material (e.g., glass fiber) such that the supporting wire element 31 can also serve as a power cord or signal line for transmitting electricity or signals. In other words, the reflective wire 3 that includes the supporting wire element 31 can serve as a reflective electric wire, a reflective metal wire, or other wire-like materials and form various products that need to reflect light (e.g., a reflective safety fence along the roadside). However, depending on actual product requirements, in certain embodiments, the supporting wire element 31 may be omitted from the reflective wire 3 that includes the at least one reflective strip 33 and the transparent protective film 35. That is, as long as a reflective wire includes the at least one reflective strip 33 and the transparent protective film 35, such a reflective wire falls within the scope of the reflective wire 3 defined in the present disclosure.

Referring to FIG. 4, the reflective strip 33 can be provided on the supporting wire element 31 directly or indirectly. For example, depending on actual product requirements, the reflective strip 33 can be disposed with an adhesive layer (e.g., glue or hot-melt adhesive) first, so as to be indirectly provided on the surface of the supporting wire element 31. In certain embodiments, the reflective strip 33 can be wrapped directly around the supporting wire element 31 by a force that winds and tightens the reflective strip 33, so that the reflective strip 33 tightly abuts the surface of the supporting wire element 31. The reflective strip 33 includes a film layer 331 and a plurality of reflective balls 333. Each reflective ball 333 can be a light-permeable bead with high clarity and with a mirror coating layer provided on half of the spherical surface as a reflective layer for retroreflection. However, the present disclosure is note limited thereto, and as long as the structure of a reflective ball 333 meets the reflection requirements of a product, such a reflective ball 333 does not have to be configured with the above-referenced material and structure.

Referring to FIG. 4, in certain embodiments, one side (hereinafter referred to as the first side) of the film layer 331 can be fixedly coated with the reflective balls 333, and the other side, that is, the second side, of the film layer 331 can abut directly or indirectly the supporting wire element 31 and, depending on product requirements, may or may not be provided with an adhesive layer. In certain embodiments, the first side of the film layer 331 can be coated with an adhesive 332 first, and then the reflective balls 333 can be evenly arranged on the adhesive 332 via electrostatic induction or other means, and be fixed by the adhesive 332. To ensure satisfactory retroreflection, in certain embodiments, the height to which the adhesive 332 covers a reflective ball 333 from the bottom of the reflective ball 333 is equal to or smaller than one half of the height of the reflective ball 333. In certain embodiments, the height to which the adhesive 332 covers a reflective ball 333 from the bottom of the reflective ball 333 is less than one third of the height of the reflective ball 333.

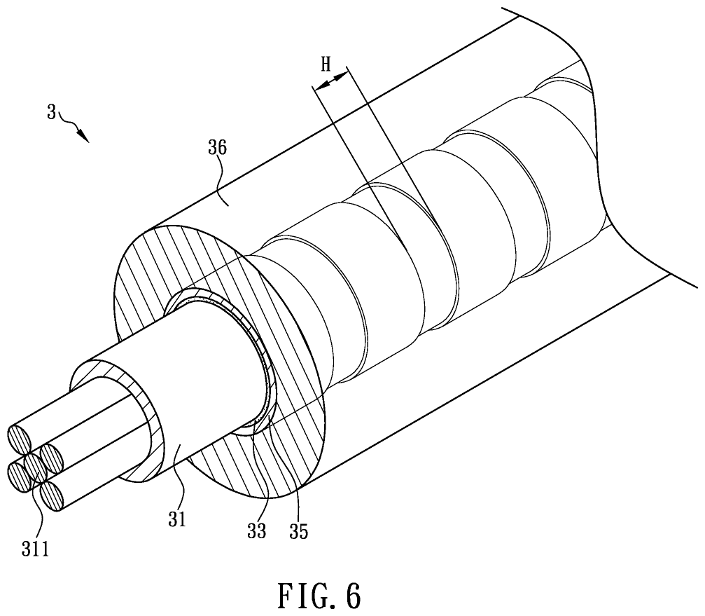

Referring to FIG. 5, in certain embodiments, the reflective strip 33 is windingly or weavingly wrapped around the surface of the supporting wire element 31 without using adhesive. The corresponding edges of each two adjacent turns of the reflective strip 33 can overlap, as indicated by the overlapping portion L in FIG. 5, and the width of the overlapping portion L between each two adjacent turns of the reflective strip 33 can be 10% to 50% of the width of the film layer 331. In certain embodiments, the reflective strip 33 is windingly or weavingly wrapped around on the surface of the supporting wire element 31, and the corresponding edges of each two adjacent turns of the reflective strip 33 can abut or substantially abut each other. In certain embodiments, referring to FIG. 6, the reflective strip 33 is windingly or weavingly wrapped around the surface of the supporting wire element 31, and the corresponding edges of each two adjacent turns of the reflective strip 33 can be spaced apart by a distance H.

Referring to FIG. 4, the transparent protective film 35 can be a plasticized material and can be provided on the reflective strip 33 and the supporting wire element 31 (e.g., by winding or weaving). The transparent protective film 35 can apply a constricting force to the reflective balls 333 and accordingly position the reflective balls 333 securely between the transparent protective film 35 and the film layer 331 while allowing gaps G to be formed between the reflective balls 333 to enable passage of air. In certain embodiments, the transparent protective film 35 has a width ranging from 1.0 mm to 4.0 mm and a thickness ranging from 0.01 mm to 0.05 mm such that the surfaces of the reflective balls 333 of the reflective wire 3 are covered by the transparent protective film 35 and kept from direct exposure to the outside. Accordingly, when the reflective wire 3 is being used or processed, the reflective balls 333 can maintain desirable reflectivity without being worn away by an external object, and foreign matter (e.g., dirt, grease, rain, or the fluid plastic used in subsequent processing) is prevented from building up in the gaps G between the reflective balls 333. That is, the gaps G that exist between adjacent reflective balls 333 to enable passage of air can make retroreflection by the reflective balls 333 possible, and the expected reflectivity of the reflective wire 3 will not be lost or significantly reduced due to obstruction by, or the scattering effect of, any foreign matter buildup.

Referring to FIG. 6, in certain embodiments, when the reflective strip 33 is wrapped around the surface of the supporting wire element 31, and the corresponding edges of each two adjacent turns of the reflective strip 33 are spaced apart by the distance H, the transparent protective film 35 can cover the reflective strip 33 and the supporting wire element 31 at the same time, or cover only the reflective strip 33 but not the supporting wire element 31. In the latter case, only those reflective balls 333 corresponding to the boundaries of the transparent protective film 35 will be exposed, so most of the reflective balls 333 are still well protected and can provide the intended retroreflection during use, thereby allowing the reflective wire 3 to have the expected reflecting effect.

It is noted that in certain embodiments, the supporting wire element 31 may be omitted from the reflective wire 3. That is, a manufacturer can just wrap the transparent protective film 35 on the reflective strip 33 to form the reflective wire 3, and then the reflective wire 3 so formed can be processed to be assembled with other components. Since the reflective balls 333 (or most of them) are not exposed, the reflective balls 333 (or the unexposed majority of them) are kept from being worn away by an external object (e.g., a mold) during subsequent processing, and no foreign matter (e.g., dirt, grease, rain, or the fluid plastic used in subsequent processing) is allowed to build up in the gaps G between the reflective balls 333. In addition, as used herein, the term “gaps G that enable passage of air” means gaps that provide space for air and deny access of larger foreign matter (either fluid or solid) sufficient to affect retroreflection, which does not include smaller foreign matter insufficient to affect retroreflection (e.g., a small amount of nanoscale particles).

Referring to FIG. 4 and FIG. 5, the outer surface of the transparent protective film 35 can be additionally provided with a plasticized coating layer 36 (whose thickness can be, but is not limited to, 0.50 mm to 3.00 mm). The plasticized coating layer 36 can be formed by extrusion molding, film blowing, or the like, so as to give extra protection to the reflective balls 333 and thereby extend the service life of the reflective strip 33, so that the surface of the reflective strip 33 will not be worn or scratched, any reflective ball 333 will not fall off, and the gaps G between the reflective balls 333 will not be filled with dirt/grime or liquid (e.g., rain) due to the application of an external force or the existence of such contaminants as dirt or grime during subsequent processing or during use, thereby preventing the reflective wire 3 from losing the optimal warning ability that can be achieved with retroreflection. The plasticized coating layer 36 can also produce a certain scattering effect, allowing the reflective wire 3 to reflect light over a larger area and accordingly produce a better reflecting effect during use than without the plasticized coating layer 36. In certain embodiments, an ultraviolet (UV)-resistant coating layer can be coated and disposed between the transparent protective film 35 and the plasticized coating layer 36 to provide the reflective wire 3 with high resistance to UV.

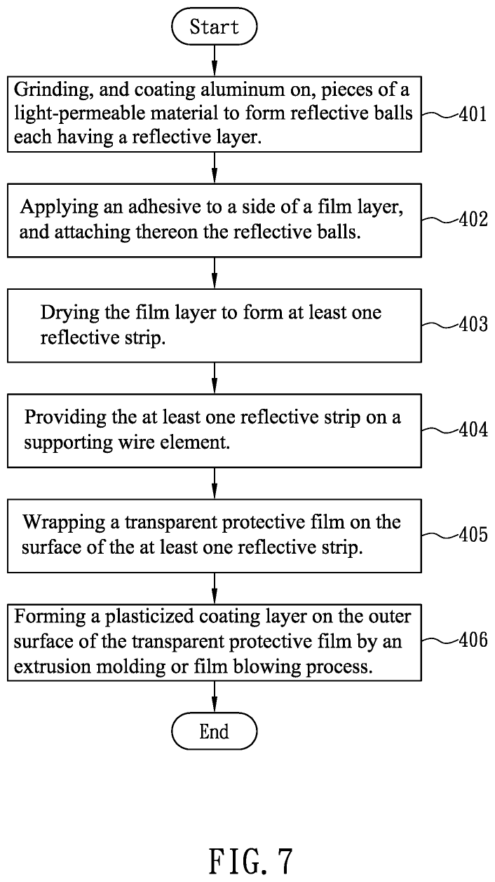

Referring to FIG. 4 and FIG. 7, a method for making the reflective wire 3 according to the present disclosure can include:
Step 401: Grinding a plurality of pieces of a light-permeable material (e.g., glass) with a grinding machine to form light-permeable beads (e.g., light-permeable glass beads), each bead being highly clear and having a smooth surface, and coating aluminum on the light-permeable beads such that half of the spherical surface of each light-permeable bead is coated with a mirror coating layer that serves as a reflective layer for retroreflection, thereby turning each light-permeable bead into a reflective ball 333 capable of retroreflection over a wide angle;
Step 402: Applying an adhesive 332 to a side of the film layer 331, and attaching the reflective balls 333 to, and positioned the reflective balls 333 on, the side of the film layer 331 via the adhesive 332;
Step 403: Drying the film layer 331 to cure the adhesive 332 and fix the reflective balls 333 on the side of the film layer 331 to form at least one reflective strip 33;
Step 404: Providing the at least one reflective strip 33 on the surface of the supporting wire element 31;
Step 405: Providing a transparent protective film 35 on the surface of the at least one reflective strip 33; and
Step 406: Forming a highly clear or transparent plasticized coating layer 36 on the outer surface of the transparent protective film 35 by an extrusion molding or film blowing process.

According to the above, referring to FIG. 4 to FIG. 7, the method according to the present disclosure for making the reflective wire 3 provides proper protection to the reflective balls 333 so that the reflective balls 333 will not be worn away or get dirty due to an external object during subsequent processing or use, and can therefore stay highly reflective. Moreover, the above-referenced steps can be adjusted according to actual product requirements, and in certain embodiments steps other than steps (404) and (405) may be dispensed with, as long as the aforesaid protection for the reflective balls 333 can be achieved with the provision of the gaps G formed between the reflective balls 333 to enable passage of air, and with the reflective balls 333 disposed between the film layer 331 and the transparent protective film 35. The reflective wire 3 is not only highly reflective, but also waterproof; rustproof; resistant to UV, high temperatures, low temperatures, and abrasion; and washable. Furthermore, the reflective balls 333 will not fall off easily, and the reflective wire 3 does not contain heavy metal. In addition, the plasticized coating layer 36 advantageously contributes to enhanced condensation of light, reflection over a large area, reflection over a length equal to or greater than 30 m, reflection in 360 degrees, the formation of a wire-like material having a circular cross section, 3-dimensional reflection, ease of use in reflective applications, and a long service life.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A reflective wire, comprising:
at least one reflective strip, comprising a film layer and a plurality of reflective balls, wherein one side of the film layer is fixedly coated with the reflective balls; and
a transparent protective film provided on the at least one reflective strip, wherein gaps allowing passage of air are formed between the reflective balls.

2. The reflective wire according to claim 1, further comprising a supporting wire element, wherein the at least one reflective strip is provided on the supporting wire element, and the other side of the film layer abuts the supporting wire element.

3. The reflective wire according to claim 1, further comprising a transparent plasticized coating layer provided on an outer surface of the transparent protective film.

4. The reflective wire according to claim 2, wherein the supporting wire element is made of at least one of a metal material and a plasticized material.

5. The reflective wire according to claim 1, wherein each of the reflective balls is a light-permeable bead, and half of a spherical surface of the light-permeable bead has a mirror coating layer as a reflective layer for retroreflection.

6. The reflective wire according to claim 2, wherein the at least one reflective strip is windingly or weavingly wrapped around a surface of the supporting wire element, and corresponding edges of each two adjacent turns of the at least one reflective strip abut or substantially abut each other.

7. The reflective wire according to claim 2, wherein the at least one reflective strip is windingly or weavingly wrapped around a surface of the supporting wire element, and corresponding edges of each two adjacent turns of the at least one reflective strip overlap.

8. The reflective wire according to claim 7, wherein a width of an overlapping portion between each two adjacent turns of the at least one reflective strip is 10% to 50% of a width of the film layer.

9. The reflective wire according to claim 2, wherein the at least one reflective strip is windingly or weavingly wrapped around a surface of the supporting wire element, and corresponding edges of each two adjacent turns of the at least one reflective strip are spaced apart by a distance.

10. The reflective wire according to claim 3, wherein the transparent protective film has a width ranging from 1.0 mm to 4.0 mm and a thickness ranging from 0.01 mm to 0.05 mm, and the plasticized coating layer has a thickness ranging from 0.50 mm to 3.00 mm.

11. A method for making a reflective wire, comprising:
fixing a plurality of reflective balls to a side of a film layer to form at least one reflective strip; and
providing a transparent protective film on a surface of the at least one reflective strip to form the reflective wire, wherein the reflective balls are disposed between the transparent protective film and the film layer, and gaps allowing passage of air are formed between the reflective balls.

12. The method according to claim 11, further comprising:
providing the at least one reflective strip on a supporting wire element with the other side of the film layer abutting the supporting wire element, before providing the transparent protective film on the at least one reflective strip.

13. The method according to claim 12, wherein the supporting wire element is a wire made of a malleable material by extrusion molding, and the malleable material is made of at least one of a metal material and a plasticized material.

14. The method according to claim 11, further comprising:
coating aluminum on half of a spherical surface of each of light-permeable beads that is ground smooth by a grinding machine to form a mirror coating layer on the half of the spherical surface as a reflective layer for retroreflection, and to form the reflective balls capable of retroreflection.

15. The method according to claim 12, wherein the supporting wire element is embedded therein with at least one wire core made of an electrically conductive metal or a fibrous material.

16. The method according to claim 11, the step of forming the at least one reflective strip comprising:
applying an adhesive to the side of the film layer;
attaching the reflective balls to, and positioned the reflective balls on, the side of the film layer via the adhesive; and
drying the film layer to cure the adhesive and fix the reflective balls on the side of the film layer.

17. The method according to claim 12, comprising:
windingly or weavingly wrapping the at least one reflective strip around a surface of the supporting wire element with corresponding edges of each two adjacent turns of the at least one reflective strip abutting or substantially abutting each other.

18. The method according to claim 12, comprising:
windingly or weavingly wrapping the at least one reflective strip around a surface of the supporting wire element with corresponding edges of each two adjacent turns of the at least one reflective strip overlapping.

19. The method according to claim 12, comprising:
windingly or weavingly wrapping the at least one reflective strip around a surface of the supporting wire element with corresponding edges of each two adjacent turns of the at least one reflective strip being spaced apart by a distance.
